(19) United States
(12) Patent Application Publication
(10) Pub. No.: US 2023/0142652 A1
(43) Pub. Date: May 11, 2023

(54) DEBRIS COLLECTION SYSTEM

(71) Applicant: Generac Power Systems, Inc., Waueksha, WI (US)

(72) Inventor: Anthony Orgain, South Burlington, VT (US)

(73) Assignee: Generac Power Systems, Inc., Waueksha, WI (US)

(21) Appl. No.: 17/522,483

(22) Filed: Nov. 9, 2021

(51) Int. Cl. A01G 20/47; A01D 34/412

(52) U.S. Cl. CPC A01G 20/47; A01D 34/412; A01D 2101/00

(57) ABSTRACT

The present disclosure relates generally to debris collection machines configured to deposit collected debris directly into a disposable collection bag. The machine can include a collection assembly in communication with a vacuum assembly. The collection assembly can include a support frame being sized and shaped to receive a collection bag. The assembly can also include a cover having a permeable member and a clamping section, the cover being connected to the outlet of the vacuum assembly and connected to the clamping section. The cover can have an open position and a closed position, wherein, when in the closed position the clamping section secures a portion of the collection bag between the clamping section and the support frame.

### BACKGROUND

Debris collection machines are used to collect debris and yard waste, such as leaves and grass clippings. Some types of existing machines have a wheeled chassis supporting a motorized fan system to generate a vacuum to collect the yard waste. With such machines, a permanent collector bag, such as a permeable cloth or fabric bag is frequently used. In many applications, the collector bag and the vacuum apparatus connected to the collector bag are arranged such that the collector bag is difficult to fully fill and/or such that removal of the collector bag is cumbersome and results in undesirable spillage. Further, the use of a permanent collector bag requires the transfer of collected contents, such as to a disposable bag. Therefore, improvements in debris collection machines are needed.

### SUMMARY

The present disclosure relates generally to debris collection machines. In one possible configuration, and by non-limiting example, a debris collection machine includes a vacuum assembly including a chassis including wheels mounted to the chassis, a motor mounted to the chassis, a housing having an inlet and an outlet, a fan powered by the motor and positioned within the housing, and the fan having a plurality of blades. The machine can also include a collection assembly in communication with the outlet of the housing of the vacuum assembly, the collection assembly including a support frame being sized and shaped to receive a collection bag, a cover including a permeable member and a clamping section, the cover being connected to the outlet of the vacuum assembly and connected to the clamping section, wherein the cover has an open position and a closed position, wherein, when in the closed position, the clamping section secures a portion of the collection bag between the clamping section and the support frame.

In some examples, the support frame that receives the clamping interface forms a bag receptacle ring.

In some examples, the bag receptacle ring is rectangular.

In some examples, the cover further includes an outer lid, the lid enclosing the permeable guard and clamping interface, wherein the lid has at least one vent.

In some examples, the cover is hingedly connected to the chassis.

In some examples, the cover includes a latch, the latch being configured to selectably connect the cover to the support frame.

In some examples, the wheels are propelled by a belt rotatable by an engine.

In some examples, the chassis further includes a bag support platform.

In some examples, the bag support platform is configured to support the collection bag in a vertical position.

In some examples, the bag support platform is foldable between a support position and a storage position.

In some examples, a handle is rotatably connected to the chassis, the handle being movable between an operating position and a storage position.

In some examples, the motor supports the cover when the cover is in the open position.

In some examples, the collection bag is non-permeable.

In some examples, the collection bag is a paper bag having a generally rectangular cross-section.

A debris collection assembly for a debris collection machine can include a support frame including a main frame sized and shaped to be received into a collection bag; a cover including a shroud portion and a clamping section, the shroud portion including an opening for receiving an outlet of a debris conveyance tube, wherein the cover has an open position and a closed position, wherein, when in the closed position, the clamping section forms a clamping interface with the support frame such that a collection bag can be clamped between the clamping section and the support frame.

In some examples, the support frame has a generally rectangular shape.

In some examples, the support frame has a generally round cross-sectional shape and the clamping section has a clamping surface having a semi-circular cross-sectional shape.

In some examples, the support frame further includes a support member extending from the main frame, the support member being for attaching the support frame to the debris collection machine.

In some examples, a latch assembly is provided and mounted to the cover.

In some examples, the support frame further includes a latch bar extending from the main frame, the latch bar being configured for engagement with the latch assembly.

In some examples, the shroud portion defines one or more vent openings.

In some examples, the shroud portion is rotatable with respect to the main frame.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a top front left perspective view of a debris collection machine with a collection bag, according to one example of the present disclosure.

FIG. 2 is a top rear left perspective view of the debris collection machine of FIG. 1.

FIG. 2A is a top rear left perspective view of the debris collection machine of FIG. 1, with the collection bag removed.

FIG. 3 is a bottom front left perspective view of the debris collection machine of FIG. 1.

FIG. 4 is a top front right perspective view of the debris collection machine of FIG. 1.

FIG. 5 is a right side view of the debris collection machine of FIG. 1.

FIG. 6 is a left side view of the debris collection machine of FIG. 1.

FIG. 7 is a front view of the debris collection machine of FIG. 1.

FIG. 8 is a rear view of the debris collection machine of FIG. 1.

FIG. 8A is a rear view of the debris collection machine of FIG. 1, with the collection bag removed.

FIG. 9 is a top view of the debris collection machine of FIG. 1.

FIG. 10 is a bottom view of the debris collection machine of FIG. 1.

FIG. 11 is a cross-sectional view of the debris collection machine of FIG. 1, taken along the line 11-11 in FIG. 9.

FIG. 12 is a perspective view of the debris collection machine of FIG. 1, with a cover of the machine placed in an open position and during an installation step of the collection bag.

FIG. 13 is an enlarged view of a portion of FIG. 12.

FIG. 14 is another perspective view of the debris collection machine of FIG. 1, with a cover of the machine placed in an open position and during an installation step of the collection bag.

FIG. 15 is an enlarged view of a portion of FIG. 14.

FIG. 16 is another perspective view of the debris collection machine of FIG. 1, with a cover of the machine placed in an open position and during an installation step of the collection bag.

FIG. 17 is an enlarged view of a portion of FIG. 16.

FIG. 18 is a perspective view of the debris collection machine of FIG. 1, with a cover of the machine placed in a closed position and during an installation step of the collection bag.

FIG. 19 is an enlarged view of a portion of FIG. 18.

FIG. 20 is an enlarged cutaway view of a portion of FIG. 18.

FIG. 21 is a rear end view of a portion of FIG. 18.

FIG. 22 is a cross-sectional view of a portion of the debris collection machine and collection bag of FIG. 18, taken along the line 22-22 in FIG. 21.

FIG. 23 is a top right rear perspective view of the debris collection machine of FIG. 1, placed in a storage position and with the collection bag removed.

FIG. 24 is a right side view of the debris collection machine of FIG. 23.

FIG. 24A is a left side view of the debris collection machine of FIG. 23.

FIG. 25 is a front view of the debris collection machine of FIG. 23.

FIG. 26 is a rear view of the debris collection machine of FIG. 23.

FIG. 27 is a top view of the debris collection machine of FIG. 23.

FIG. 28 is an exploded perspective view of a portion of the debris collection machine of FIG. 1.

FIG. 29 is an enlarged view of a portion of FIG. 29.

FIG. 30 is a side view of a cover of the debris collection machine of FIG. 1.

FIG. 31 is a front view of the cover of FIG. 30.

FIG. 32 is a rear view of the cover of FIG. 30.

FIG. 33 is a top view of the cover of FIG. 30.

FIG. 34 is a bottom view of the cover of FIG. 30.

FIG. 35 is a top perspective view of a clamp part of the debris collection machine of FIG. 1.

FIG. 36 is a bottom perspective view of the clamp part of FIG. 35.

FIG. 37 is a side view of the clamp part of FIG. 35.

FIG. 38 is a front view of the clamp part of FIG. 35.

FIG. 39 is a rear view of the clamp part of FIG. 35.

FIG. 40 is a top view of the clamp part of FIG. 35.

FIG. 41 is a bottom view of the clamp part of FIG. 35.

FIG. 42 is a top perspective view of a support frame of the debris collection machine of FIG. 1.

FIG. 43 is a bottom perspective view of the support frame of FIG. 42.

FIG. 44 is a side view of the support frame of FIG. 42.

FIG. 45 is a perspective exploded view of a portion of the debris collection machine of FIG. 1.

FIG. 46 is a perspective view of a rotor assembly of the debris collection machine of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

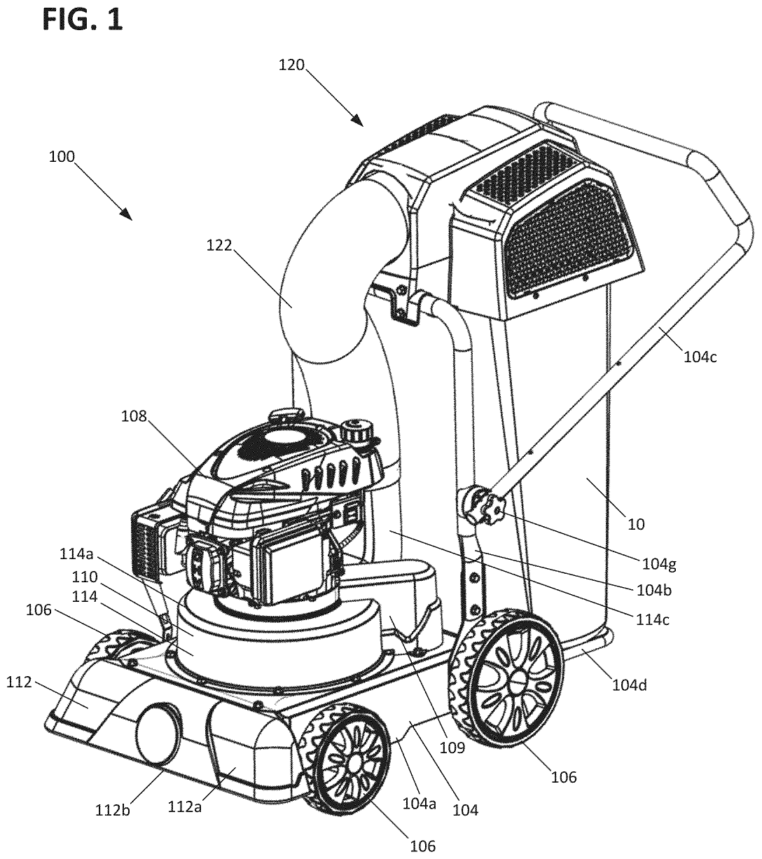

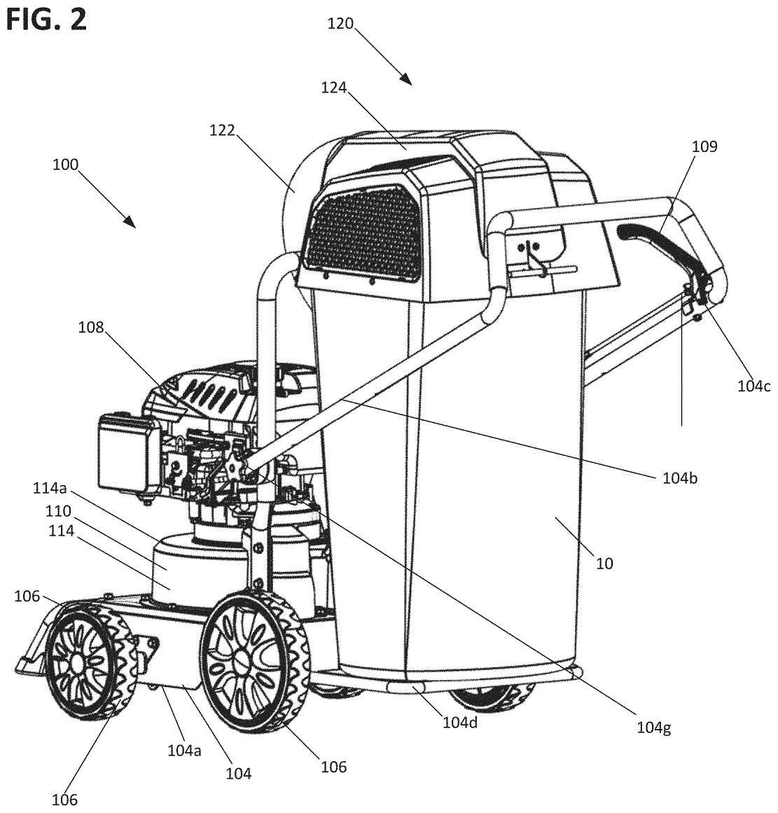

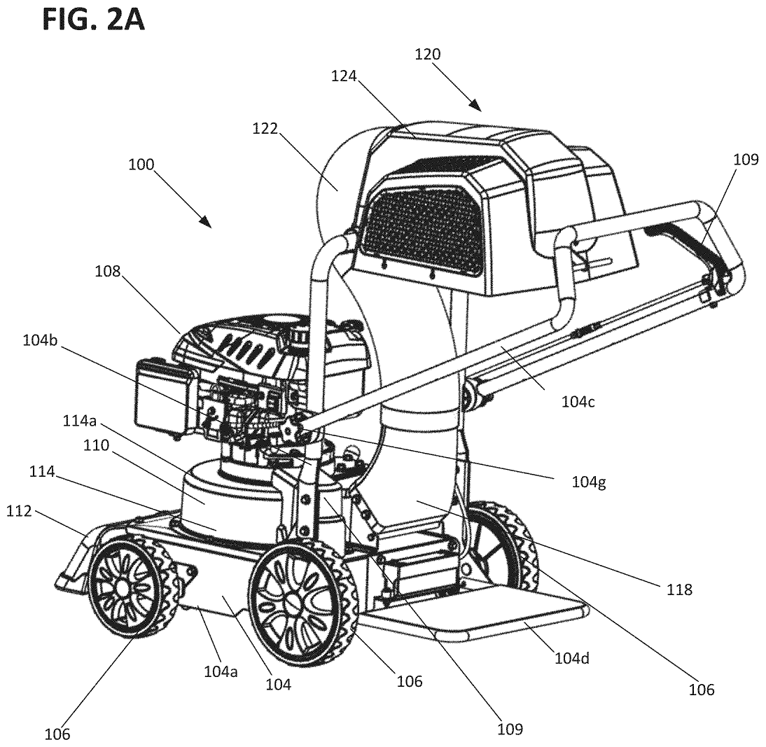

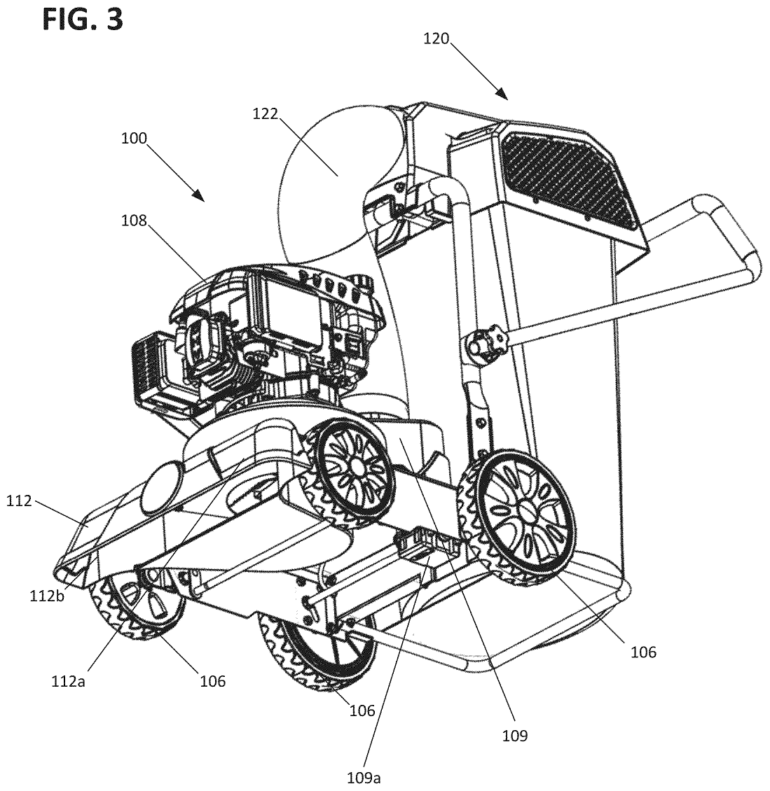

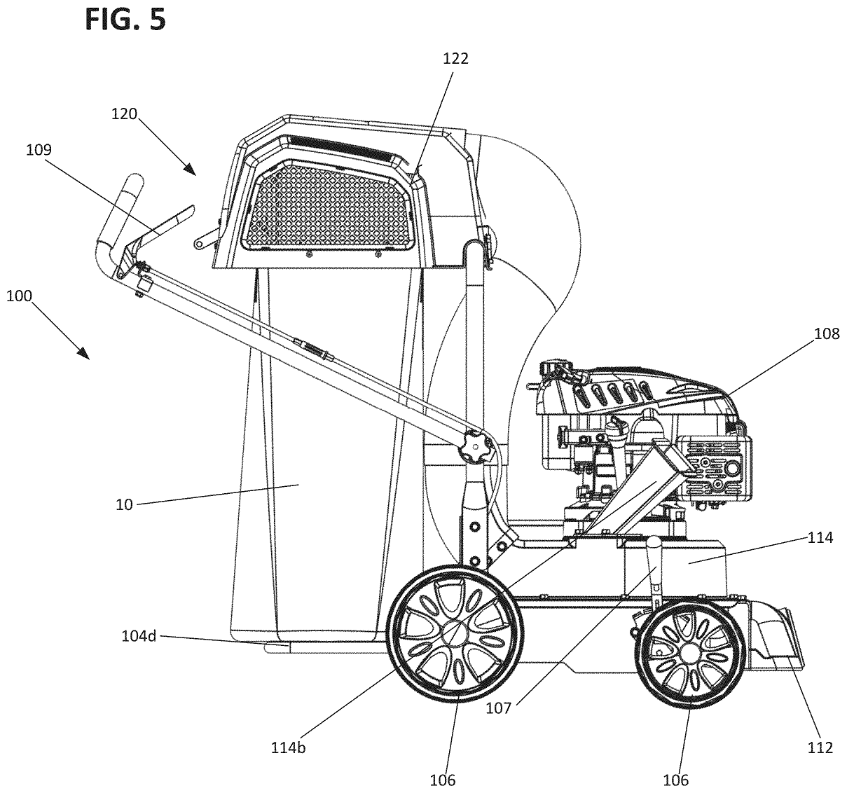

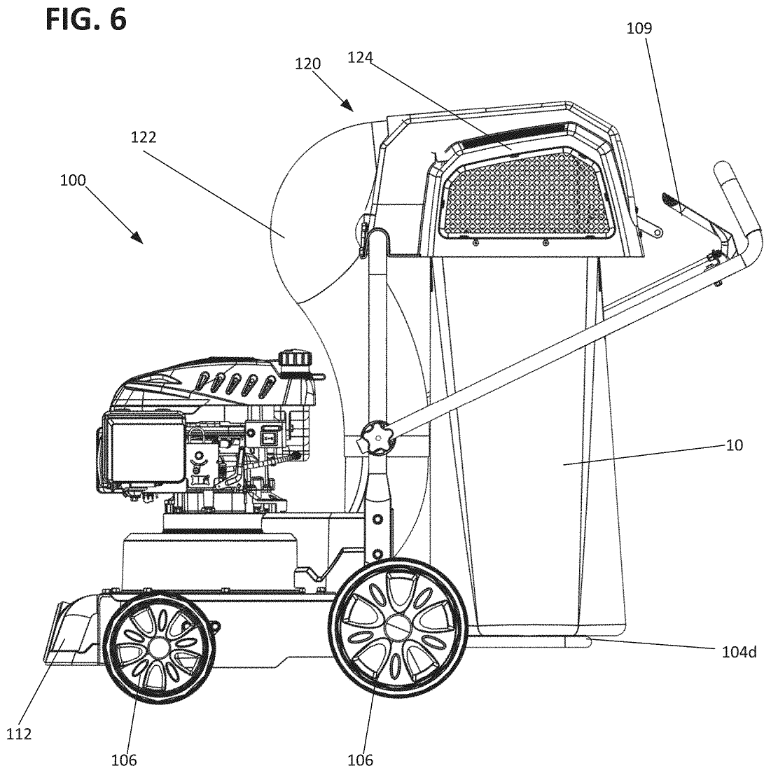

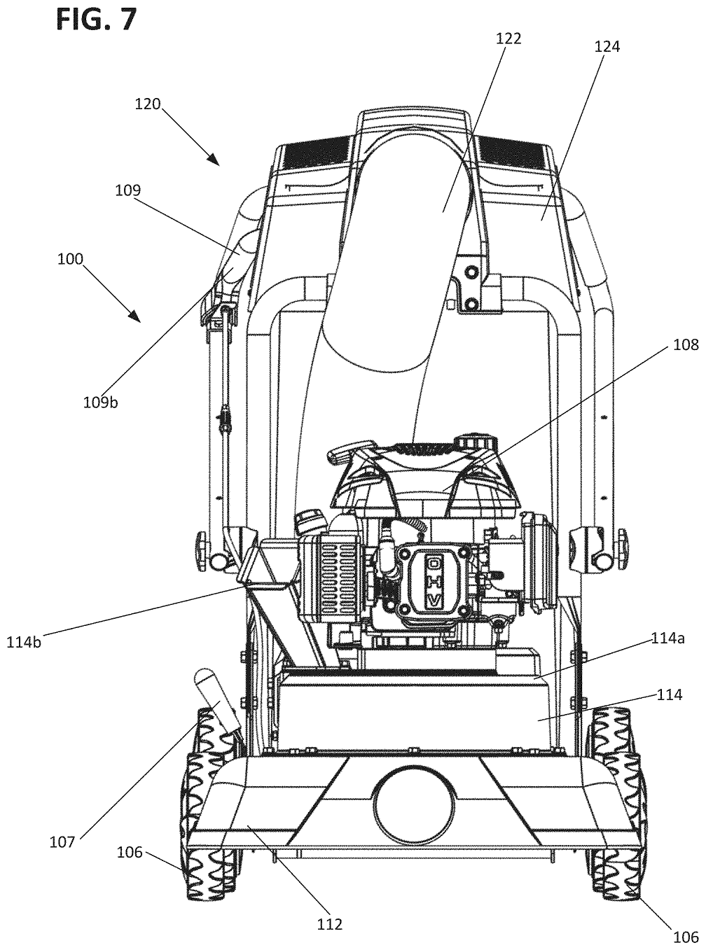

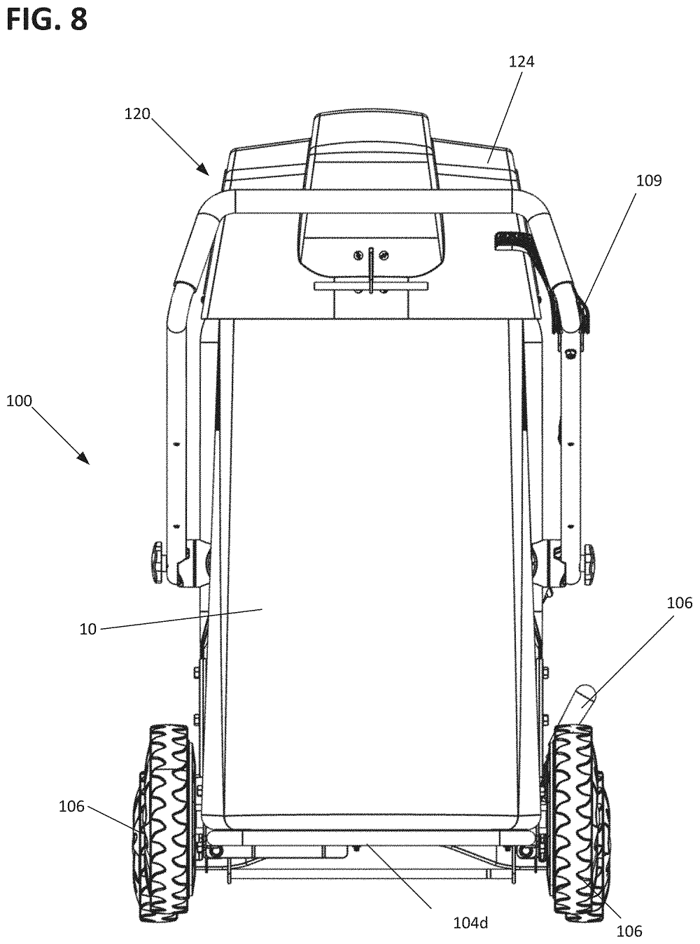

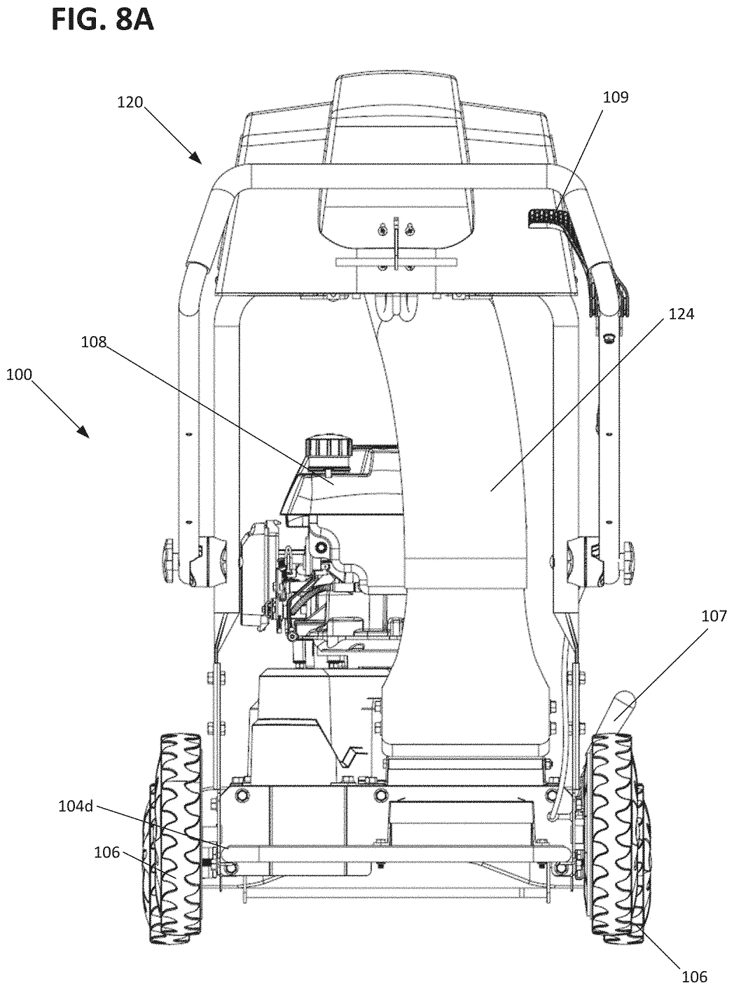

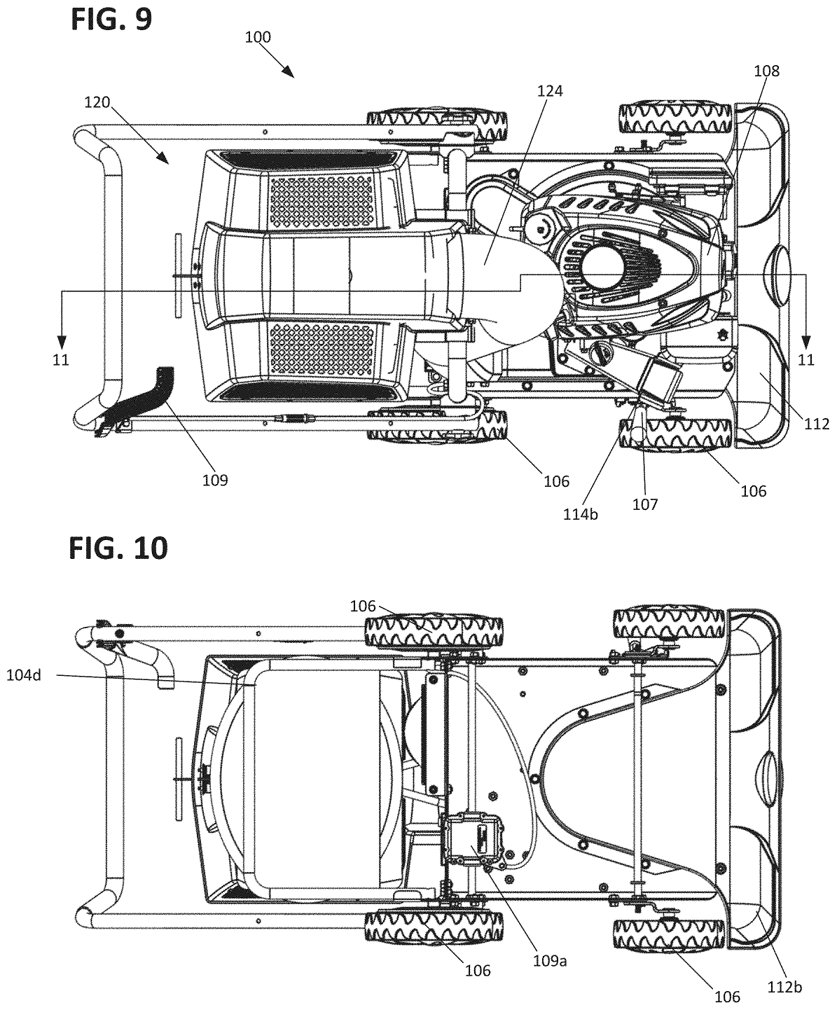

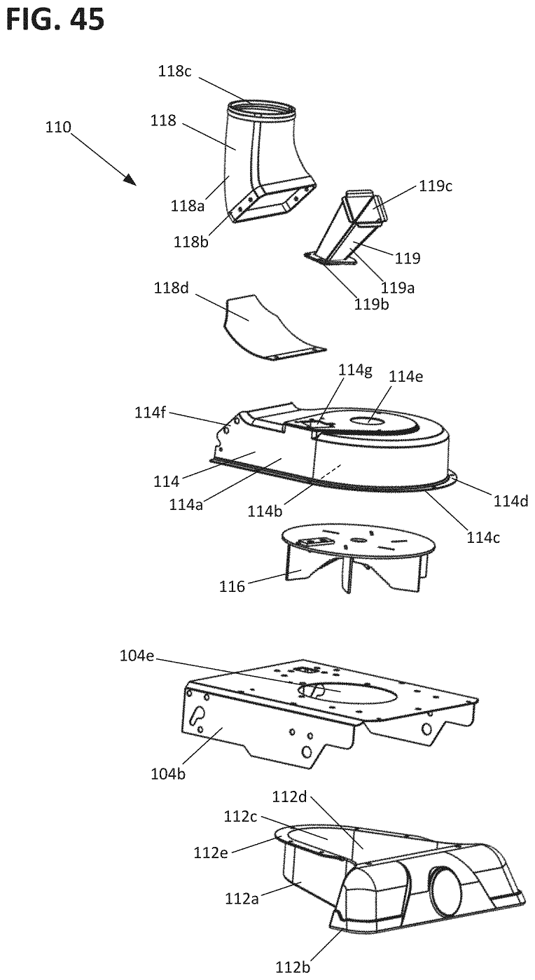

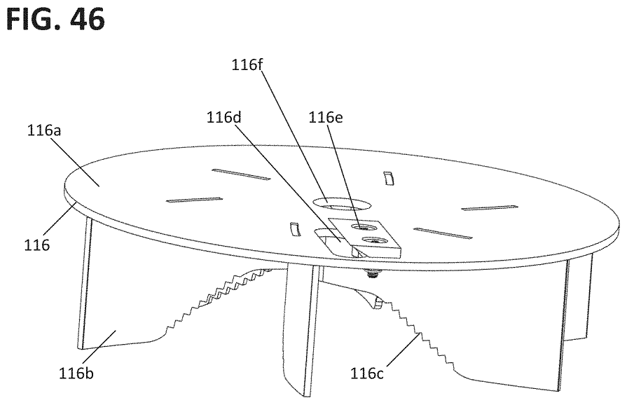

FIGS. 1 to 4 show various perspective views of a debris collection machine 100 to which a collection bag 10 is mounted, with the exception of FIG. 2A which shows the debris collection machine 100 without the collection bag 10 installed. FIGS. 5 and 6 show side views of the debris collection machine 100 and collection bag 10, while FIGS. 7 and 8 respectively show front and rear views of the same. FIG. 8A shows a rear view of the debris collection machine 100 with the collection bag 10 removed. FIGS. 9 and 10 respectively show top and bottom views of the debris collection machine 100 and collection bag 10. FIG. 11 shows a cross-sectional side view of the debris collection machine 100 and collection bag 10, as taken at line 11-11 on FIG. 9. FIGS. 45 and 46 show perspective views of components of the debris collection machine 100. As described further herein, the debris collection machine 100 is configured to generate a vacuum for collecting debris from a ground surface, such as yard waste, and is further configured to transport the debris to the collection bag 10. Non-limiting examples of yard waste are leaves, grass clippings, plant and tree trimmings, mulch, and any other vegetative organic matter.

The collection bag 10 can be any type of bag suitable for collecting yard waste. For example, the collection bag 10 can be formed from cloth, paper, or plastic and can be either permeable or non-permeable. In general terms, permeable bags allow air to flow through the wall(s) of the bag while non-permeable bags do not allow for such airflow. In the particular example presented herein, the collection bag 10 is a standard self-standing 30 gallon paper lawn/leaf collection bag widely available at retail hardware and home goods stores. Such collection bags 10 are typically formed with two-ply kraft paper and have a generally rectangular cross-section. As this type of bag is typically opened from an initially folded position, the sides generally have additional creases and folds that cause the bag to have sides that are not entirely straight and/or parallel to each other. The term “generally rectangular” used herein is intended to include such bags as they can or would have a fully or more fully rectangular cross-sectional shape were the sides held in a straightened arrangement. The most common size for such bags is 16 inches wide by 12 inches deep by 35 inches tall, although other sizes are possible. Although not required, the collection bag 10 shown in the drawings and described herein has the above-identified characteristics. The collection bag 10 can also be characterized as being compostable or biodegradable and can be configured to meet various related standards, such as ASTM D6400, ASTM D6868, and ISO 14855.

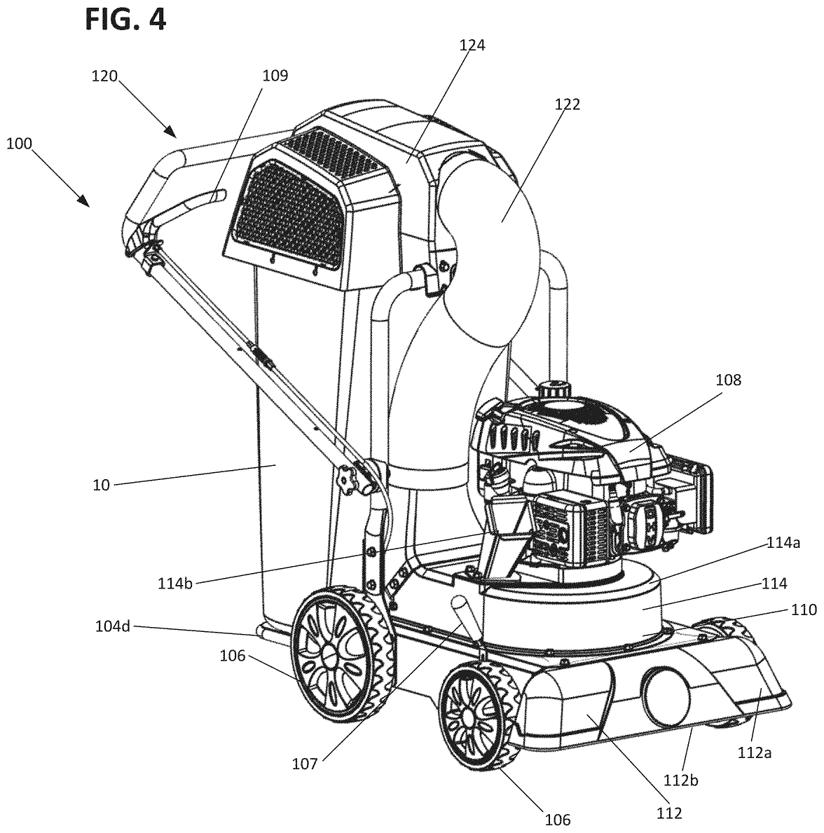

In one aspect, the debris collection machine 100 includes a chassis structure 104 that includes wheels 106. The chassis structure 104 includes a main frame 104a supporting a motor 108 and a housing arrangement 110. The chassis structure 104 is also shown as including a support frame 104b mounted to the main frame 104a and a handle 104c rotatably mounted to the support frame 104b and secured by a pair of knobs 104g. The chassis structure 104 also includes a bag support platform 104d rotatably mounted to the main frame 104a. The bag support platform 104d supports the bottom side of the collection bag 10. The housing arrangement 110 includes, in part, an inlet structure 112 and a rotor chamber housing 114. A rotor assembly 116 is also provided and is housed within the rotor chamber housing 114. The rotor assembly 116 is a rotating component that generates and airflow and/or vacuum. The rotor assembly 116 thus may be characterized as being a fan and/or an impeller. In one aspect, the aforementioned features of the debris collection machine 100 can be characterized as forming a vacuum assembly. In one aspect, and as can be seen at FIGS. 4 and 5, the debris collection machine 100 can be provided with a height adjustment mechanism 107 operably connected to the front wheels 106 so that the height of the inlet structure 112 can be adjusted, as desired for a particular application. In one aspect, the debris collection machine 100 can also be provided with a drive system 109 for propelling the rear wheels 106. The drive system 109 may be an electric drive system or a mechanical drive system. In the example shown, the drive system 109 includes a transmission/clutch arrangement 109a operably connected to the rear wheels 106, for example connected to the axle extending between the rear wheels 106. The drive system 109 can further include a drive belt (not shown) extending between a pully mounted to a shaft 108a of the motor 108 and the transmission/clutch arrangement 109a such that the motor 108 can provide power to the wheels 106. The drive system 109 can further include a lever 109b, shown as being mounted to the support frame 104b for operating the handle 104c, for enabling an operator to selectively engage and disengage the transmission/clutch arrangement 109a.

The debris collection machine 100 is also shown as including a collection assembly 120 including an outlet tube 122 and a cover assembly 124, wherein the outlet tube 122 extends between a debris discharge of the rotor chamber housing 114 and the cover assembly 124. The outlet tube 122 is flexible. As discussed in more detail later, the cover assembly 124 functions to support and retain the collection bag 10 in position such that debris collected by the vacuum assembly can be delivered to the collection bag 10.

In one aspect, the motor 108 provides power to the debris collection machine 100. In some examples, the motor 108 is an internal combustion engine. In other examples, the motor 108 is an electric moto. In other examples still, the motor 108 is a hybrid electric engine.

In one aspect, the housing arrangement 110 at least partially contains the internal components of the debris collection machine 100. FIG. 45 shows these components in an exploded view. In one aspect, the inlet structure 112 is mounted at a front end of the support frame 104b of the chassis structure 104. As shown, the inlet structure 112 has a main body 112a extending between an inlet end 112b, which is downward facing relative to the ground, and an outlet end 112c, which is upward facing relative to the ground. As such, the main body 112a defines an interior flow passageway 112d extending between the inlet and outlet ends 112b, 112c. The main body 112a is further shown as including a flange 112e for enabling the main body 112a to be mounted to the bottom side of the support frame 104b such that an opening 104e in the support frame 104b is aligned with the outlet end 112c.

In one aspect, the rotor chamber housing 114 defines a main body 114a defining a rotor cavity 114b extending between an inlet end 114c and an outlet end 114d. The rotor cavity 114b receives the rotor assembly 116. The main body 114a is further provided with a shaft opening 114e such that the shaft 108a of the motor 108 can extend through the rotor chamber housing 114 and connect to the rotor assembly 116. The main body 114a is also provided with a collection outlet 114f and a chipper inlet 114g.

The rotor assembly 116 is rotationally powered by the motor 108, via connection to the shaft 108a, and is positioned within the rotor cavity 114b. The rotor assembly 116 is shown in the cross-section of FIG. 11 and in isolation at FIGS. 45 and 46. In one aspect, the rotor assembly 116 includes a base plate 116a and a plurality of vanes 116b affixed to the base plate 116a. When the rotor assembly 116 rotates, the vanes 116b generate a negative air pressure on the side of the rotor assembly 116 facing the inlet structure 112 and a positive air pressure on the side of the rotor assembly 116 facing the collection outlet 114f and the chipper inlet 114g. The vanes 116b can be provided with serrated edges 116c to aid in reducing debris as it passes across the rotor assembly 116. As most easily seen at FIG. 46, the rotor assembly 116 is also shown as being provided with an opening 116d in the base plate 116a and a reducing element 116e adjacent the opening 116d. The reducing element 116e, in the example shown, is configured as a separate part mounted to the base plate 116a via fasteners 131 and is provided with a blade or sharp edge adjacent the opening 116d. In one aspect, debris is cut or chopped by the reducing element 116e as it rotates with the rotor assembly 116 and subsequently passes through the opening 116d. The rotor assembly 116 is also provided with a receiving structure 116f for receiving the shaft 108a and securing the rotor assembly 116 to the shaft 108a.

The housing arrangement 110 is further shown as including an outlet collar 118 having a main body 118a extending between an inlet end 118b and an outlet end 118c. The outlet end 118c of the outlet collar 118 is connected to the collection outlet 114f of the main body 114a while the outlet end 118c is connected to outlet tube 122. A transition or ramp piece 118d can also be provided at the interface between the main bodies 114a, 118a to minimize the collection or trapping of debris at the connection.

The housing arrangement 110 is also shown with an chipper inlet 119 for receiving manually-fed debris, such as tree or bush branches. The chipper inlet 119 is an optional attachment. Once fed into the chipper inlet 119, debris is cut, chopped, or otherwise reduced by the reducing element 116e, passed through the opening 116d and discharged through the collection outlet 114f, outlet collar 118, outlet tube 122, and into the collection bag 10. In one aspect, the chipper inlet 119 has a main body 119a extending between an outlet end 119b and an inlet end 119c. The outlet end 119b is connected to the chipper inlet 114g of the main body 114a. Where it is not desired to provide the debris collection machine 100 with a chipper function or where the chipper function is not in use, a plate can be mounted to the main body 114a to cover and close the chipper inlet 114g. As only a small amount of vacuum is created at the chipper inlet 114g by the rotor assembly 116, the debris collection machine 100 can operate normally without requiring a cover plate. In either configuration, all debris collected within the housing arrangement 110 will be discharged to the collection outlet 114f and further processed as previously described.

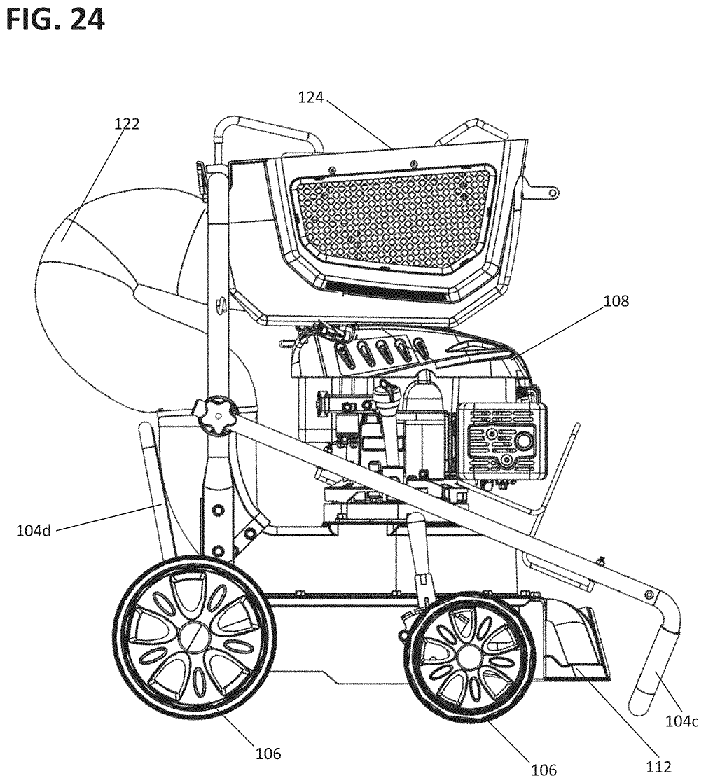

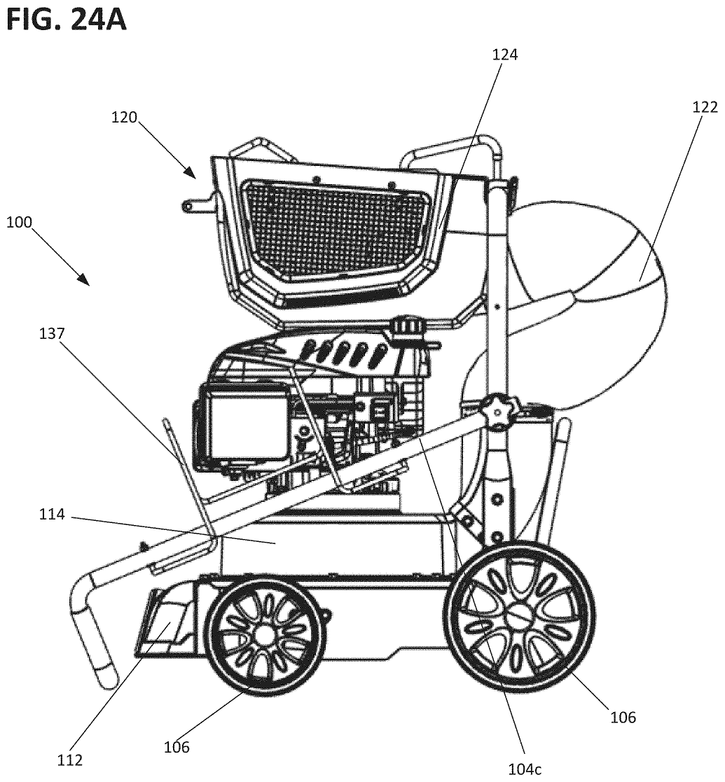

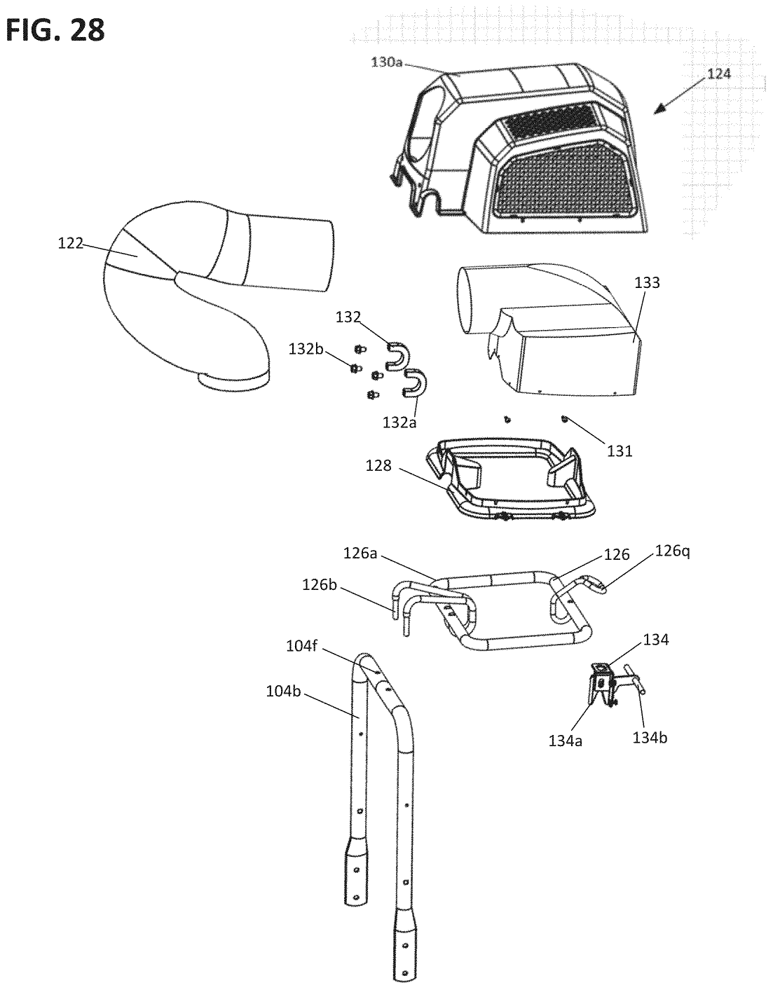

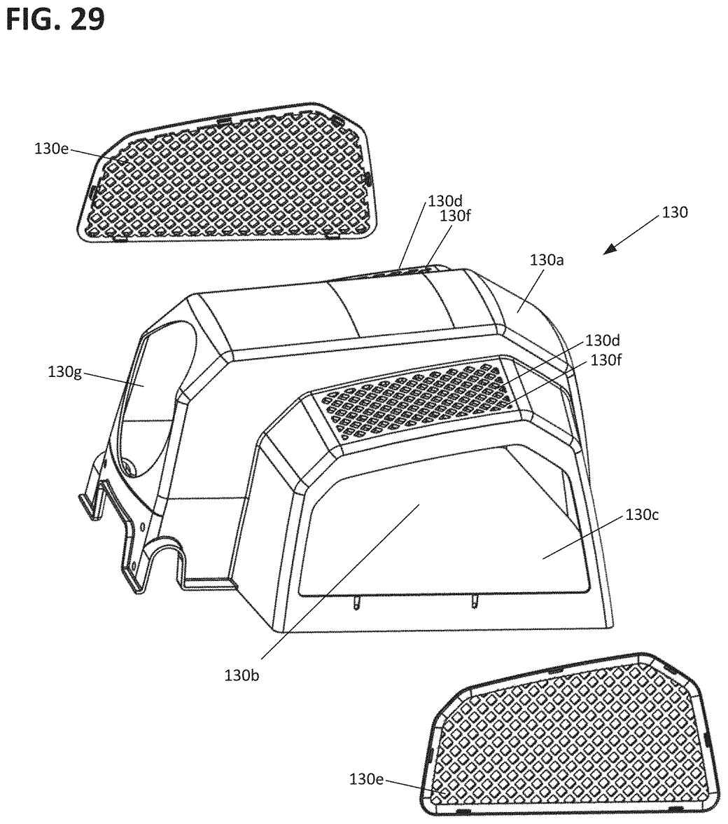

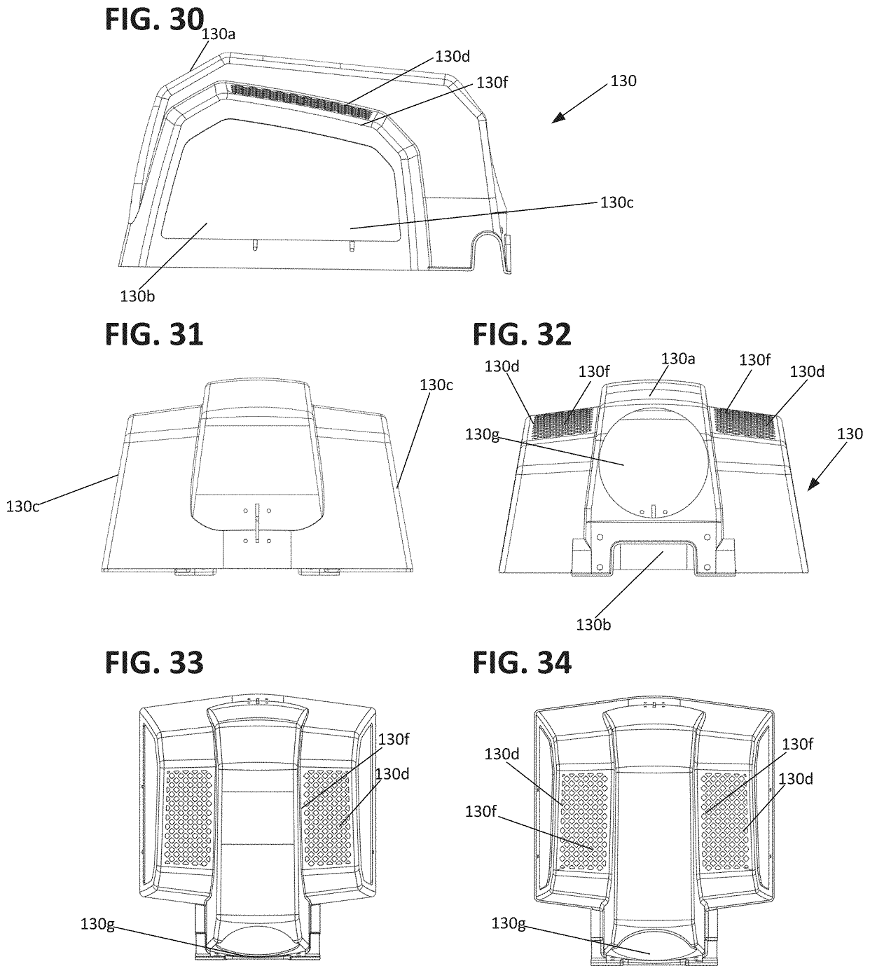

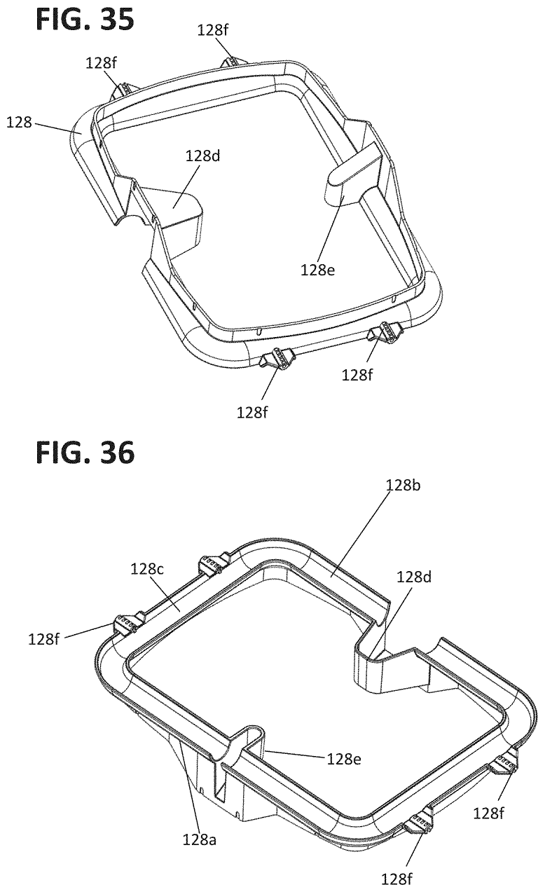

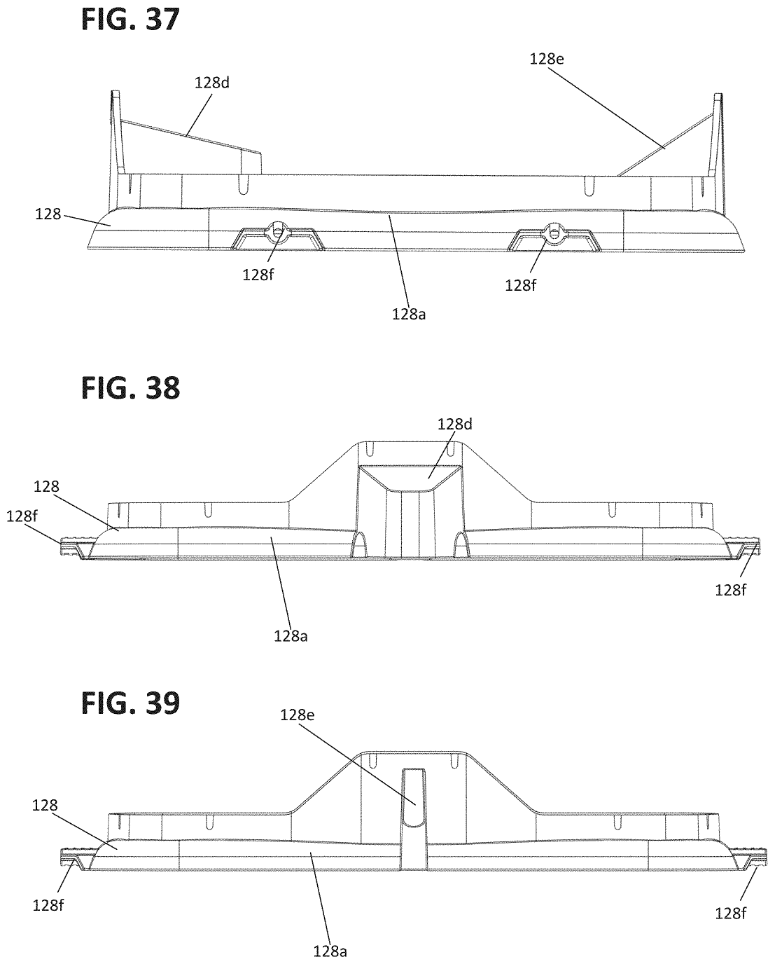

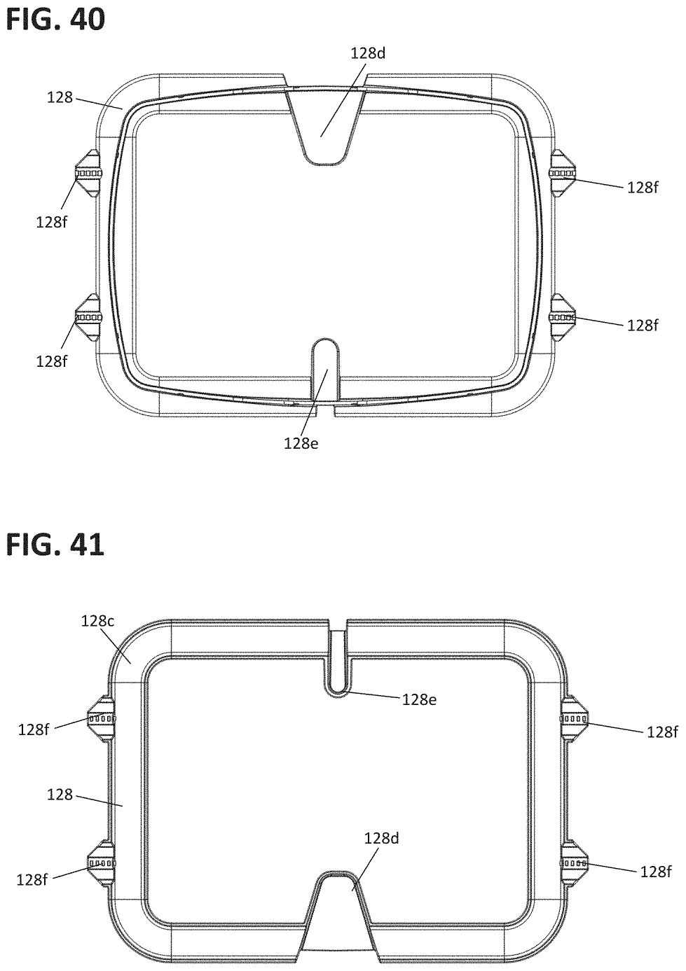

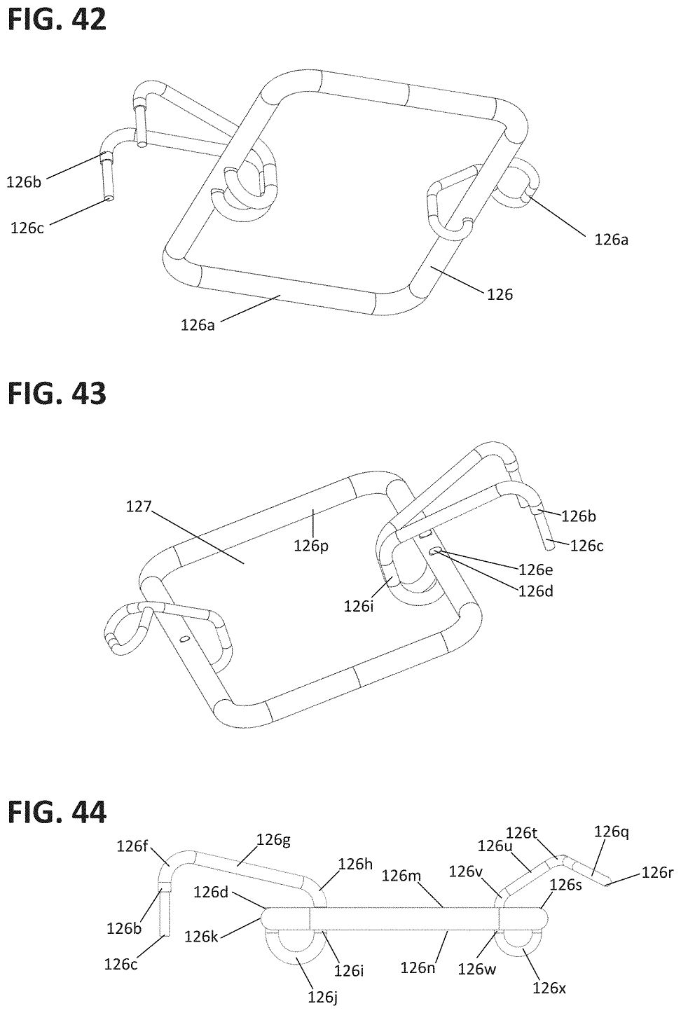

As previously indicated, the debris collection machine 100 includes a collection assembly 120 arranged to deposit debris collected discharged from the outlet collar 118 via an outlet tube 122 which is flexible connected to a cover assembly 124. FIGS. 28 to 24 show various aspects the cover assembly 124. FIG. 28 shows an exploded view of the cover assembly 124 and depicts a support frame 126, a clamping section 128, a shroud arrangement 130, an attachment arrangement 132, and a latch arrangement 134. FIG. 29 shows an exploded view of the shroud arrangement 130 while FIGS. 30 to 34 show various views of a shroud body 130a of the shroud arrangement 130 in isolation. FIGS. 35 to 41 show various views of the clamping section 128 in isolation while FIGS. 42 to 44 show various views of the support frame 126 in isolation.

In one aspect, the support frame 126 include a main frame 126a which is rectangular-shaped and formed from tubing. In the example shown, the tubing of the main frame 126a has a generally circular cross-sectional shape. Other shapes are possible. The main frame 126a has dimensions that are slightly smaller than that of the collection bag 10 and has a matching length/width aspect ratio such that the main frame 126a can be received into the collection bag 10. As shown, the main frame 126a is generally disposed along a horizontal plane such that the collection bag 10 will hang in a generally vertical orientation. However, the main frame 126a may be disposed at other angles or orientations.

In one aspect, the support frame 126 further includes a pair of support members 126b attached to the main frame 126a. The support members 126b have first end portions 126c that are received into apertures 104f of the support frame 104b such that the support members 126b can be secured to the support frame 104b, such as by welding. The support members 126b have second end portions 126d that are received into apertures 126e of the main frame 126a such that the support members 126b can be secured to the main frame 126a, for example by welding. Although two support members 126b are shown, more or fewer may be provided, such as a single support member. As shown, each support member 126b can be characterized as further having as portions 126f, 126g, 126h, 126i and 126j located between the end portions 126c, 126d, wherein portions 126f, 126h, and 126j are curved and portions 126g and 126i are straight, along with the end portions 126c, 126d. As configured, the second end portion 126d is connected to a bottom side 126n of the main frame 126a and extends in a downward direction such that the adjacent curved portion 126j is below the main frame 126a. The portion 126i extends upwardly through an interior portion 127 of the main frame 126a such that the portion 126i is spaced from the main frame 126a. The curved portion 126h, located above the main frame 126a, curves back towards the main frame 126a such that the adjacent portion 126g is spaced from the main frame 126a and extends beyond an outer perimeter 126k defined by the main frame 126a. Adjacent curved portion 126f curves downwardly to the first end portions 126c which in turn extends downwardly such that the end portions are received into a top portion of the support frame 104b at apertures 104f With such a construction, the main frame 126a is fully supported by the support members 126b while the outer surface 126k, a perimeter interior surface 126p, and a top surface 126m are completely free from obstruction by the support members 126b. As discussed later, this construction enables the main frame 126a to be received into the interior of the collection bag 10 and for the end of the collection bag 10 to be wrapped around the top surface 126m and outer surface 126k of the main frame 126a without interference from the support members 126b.

In one aspect, the support frame 126 further includes a latch bar 126q secured to the main frame 126a on a side opposite the support members 126b. As discussed later, the latch bar 126q provides a surface against which a latch mechanism can be mounted to the cover assembly 124. The latch bar 126q extends between an end portion 126r and an end portion 126s. The end portion 126r is configured as a looped latch portion 126r. As shown, latch bar 126q can be characterized as further having as portions 126t, 126u, 126v, 126w, and 126x located between the end portions 126r, 126s, wherein portions 126t, 126v, and 126x are curved and portions 126u and 126w are straight, along with the end portion 126s. As configured, the end portion 126s is connected to the bottom side 126n of the main frame 126a and extends in a downward direction such that the adjacent curved portion 126x is below the main frame 126a. The portion 126w extends upwardly through the interior portion 127 of the main frame 126a such that the portion 126w is spaced from the main frame 126a. The curved portion 126v, located above the main frame 126a curves back towards the main frame 126a outer perimeter 126k such that the adjacent portion 126u is spaced from the main frame 126a and extends beyond the outer perimeter 126k defined by the main frame 126a. The curved portion 126t curves downwardly to the end portion 126r. With such a construction, the main frame 126a is fully supported by the support members 126b while the perimeter outer surface 126k, the perimeter interior surface 126p, and the top surface 126m are completely free from obstruction by the latch bar 126q. This construction enables the main frame 126a to be received into the interior of the collection bag 10 and for the end of the collection bag 10 to be wrapped around the top surface 126m and outer surface 126k of the main frame 126a without interference from the latch bar 126q.

In one aspect, the shroud arrangement 130 and clamping section 128 are attached to each other, via fasteners 131 such as screws or bolts, and together form an assembly that is rotatably mounted to the support frame 104b via the attachment arrangement 132. Although the shroud arrangement 130 and clamping section 128 are shown as separately formed and attached components, a construction is possible in which the features of the clamping section 128 are provided on the shroud body 130a. As shown at FIG. 28, the attachment arrangement 132 includes a pair of U-shaped members 132a that receive a horizontal portion of the support frame 104b and are bolted to the shroud body 130a with fasteners 132b such that the shroud body 130a is attached to the clamping section 128 and rotate about the horizontal portion of the support frame 104b between open and closed positions. The latch arrangement 134, also mounted to the shroud body 130a, includes a latch portion 134a that engages with the looped latch portion 126r of the latch bar 126q and can be selectively engaged and disengaged from the latch bar 126q via a handle 134b of the latch arrangement 134.

As most clearly illustrated at FIGS. 29 to 34, the shroud body 130a defines an interior volume 130b with a plurality of vent openings 130c, 130d. The vent openings 130c are configured for receiving removable grill sections 130e, which are connected to the shroud body 130a via a snap-fit type connection. The vent openings 130d are formed with integral grill sections 130f. The shroud body 130a can be alternatively configured with all or no integral grill sections 130f or all or no separate removable grill sections 130e. The shroud body 130a is also configured with an opening 130g for receiving the outlet tube 122. The shroud arrangement 130 functions to receive the collected debris from the outlet tube 122 such that the debris can be deposited into the collection bag 10 while allowing for the associated volume of air generated by the rotor assembly 116 to be vented via vent openings 130c, 130d. Such a construction enables the collection bag 10 to be made from an impermeable material (e.g. kraft paper or plastic) since the airflow from the rotor assembly 116 does not flow through the collection bag 10 itself. In some examples, a cloth or mesh liner 133 (see FIGS. 11 and 28) is provided between the outlet of the outlet tube 122 and the vent openings 130c, 130d such that smaller particulate matter is trapped within the interior of the shroud body 130a and ultimately deposited within the collection bag 10. As shown, the mesh liner 133 is attached at one end to the outlet tube 122 and to the clamping section 128 at the other end such that all debris must flow from the outlet tube 122, through the clamping section 128, and into the collection bag 10 while the air conveying the debris can pass through the mesh liner 133 and vent openings 130c, 130d in the shroud body 130a.

As most clearly illustrated at FIGS. 35 to 41, the clamping section 128 is provided with a main body 128a that defines an interior portion 128b, about which a clamping surface 128c is defined. The clamping surface 128c is configured with the same height and width dimensions as the main frame 126a and is additionally provided with a shape that is complementary to the shape of the cross-sectional shape of the main frame 126a. As such, the main frame 126a and the clamping surface 128c can be characterized as having matching cross-sectional geometries. In the example configuration shown, the clamping surface 128c is provided with a semi-circular shape since the tubing of the main frame 126a is provided with a circular cross-sectional shape. Accordingly, when the cover assembly 124 is in the closed position relative to the support frame 126, the clamping surface 128c directly faces and abuts the main frame 126a to provide a clamping interface such that the collection bag 10, which is wrapped about the main frame 126a, can be clamped between the main frame 126a and the clamping surface 128c. The clamping section 128 is further provided with shroud portions 128d, 128e for respectively covering and shielding the support members 126b and latch bar 126q from incoming collected debris discharged from the outlet tube 122 as the debris drops into the collection bag 10. The clamping section 128 is further provided with a plurality of mounting structures 128f with apertures for receiving fasteners 131 such that the clamping section 128 can be secured to the shroud body 130a.

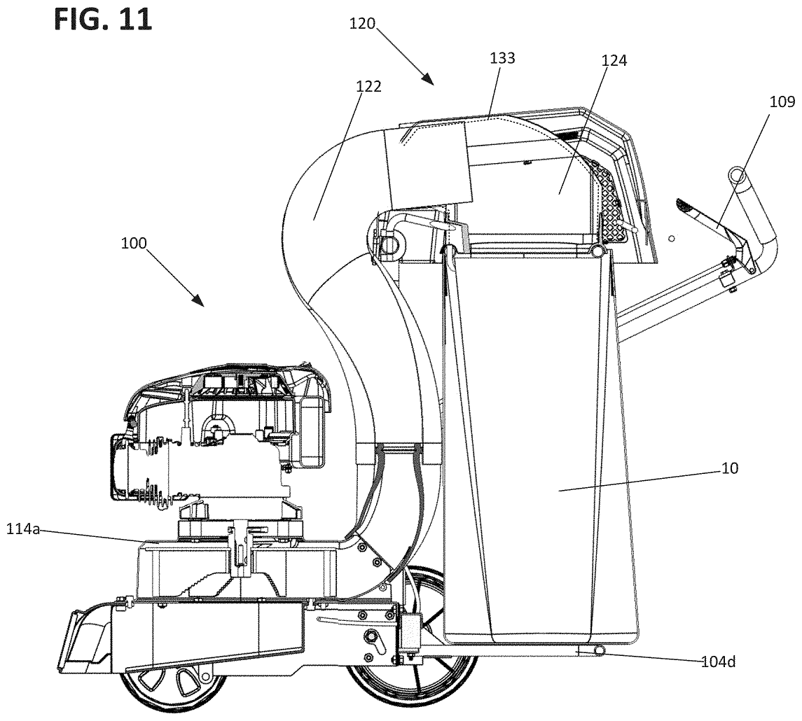

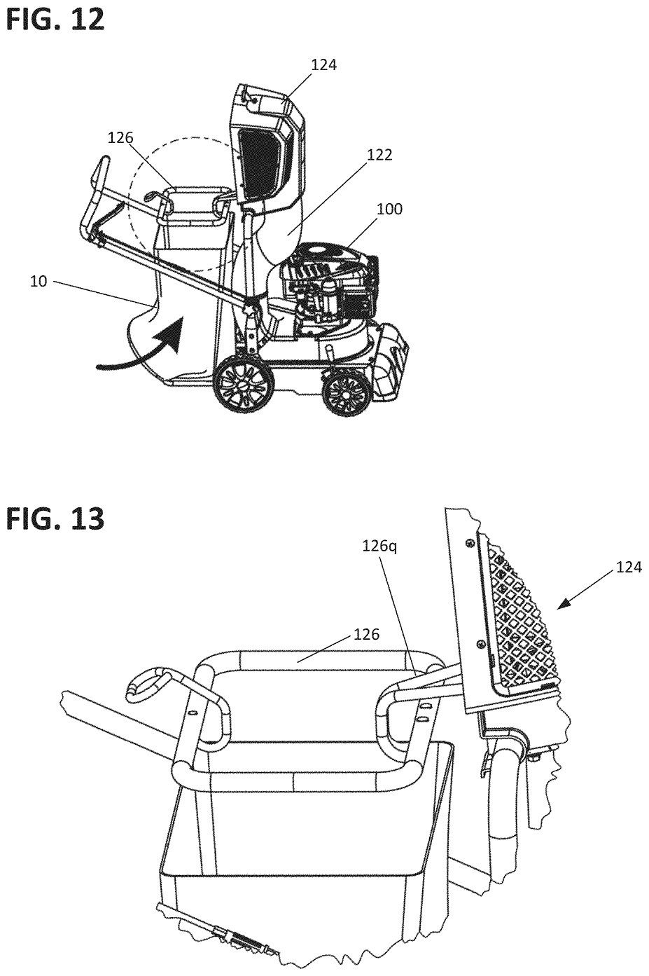

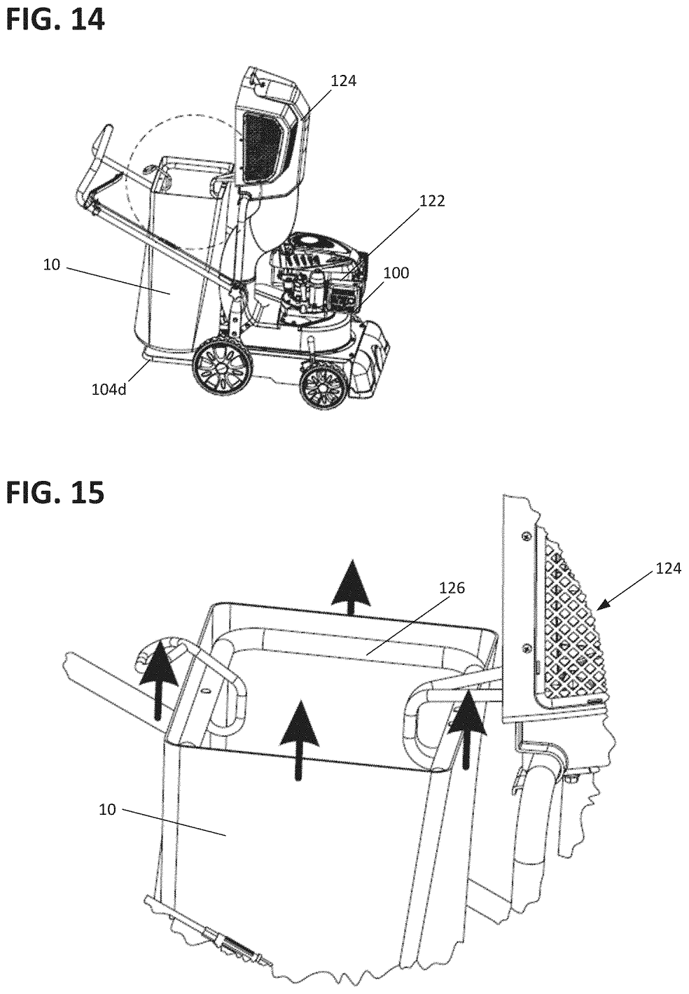

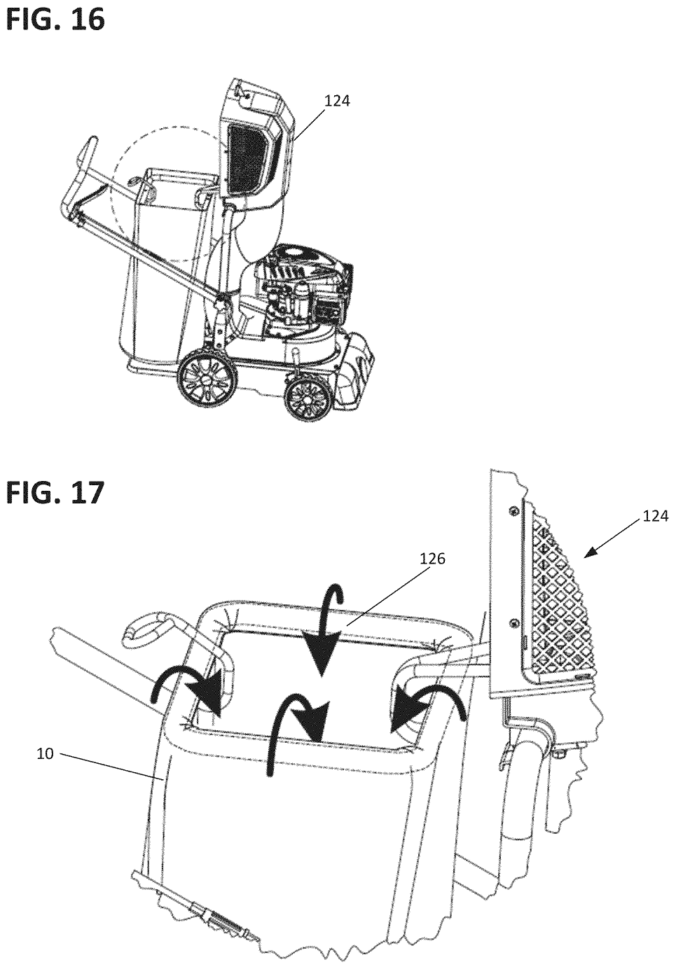

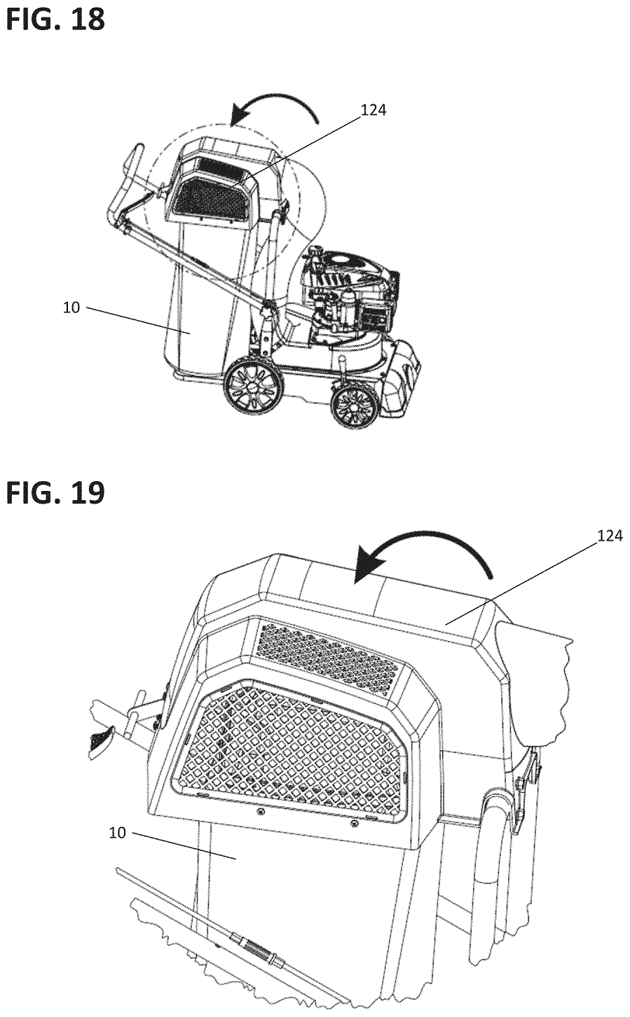

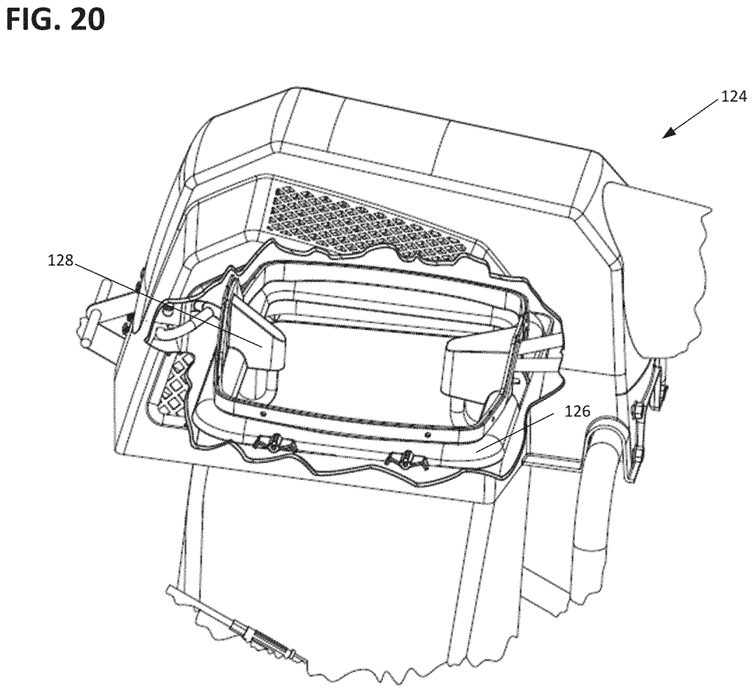

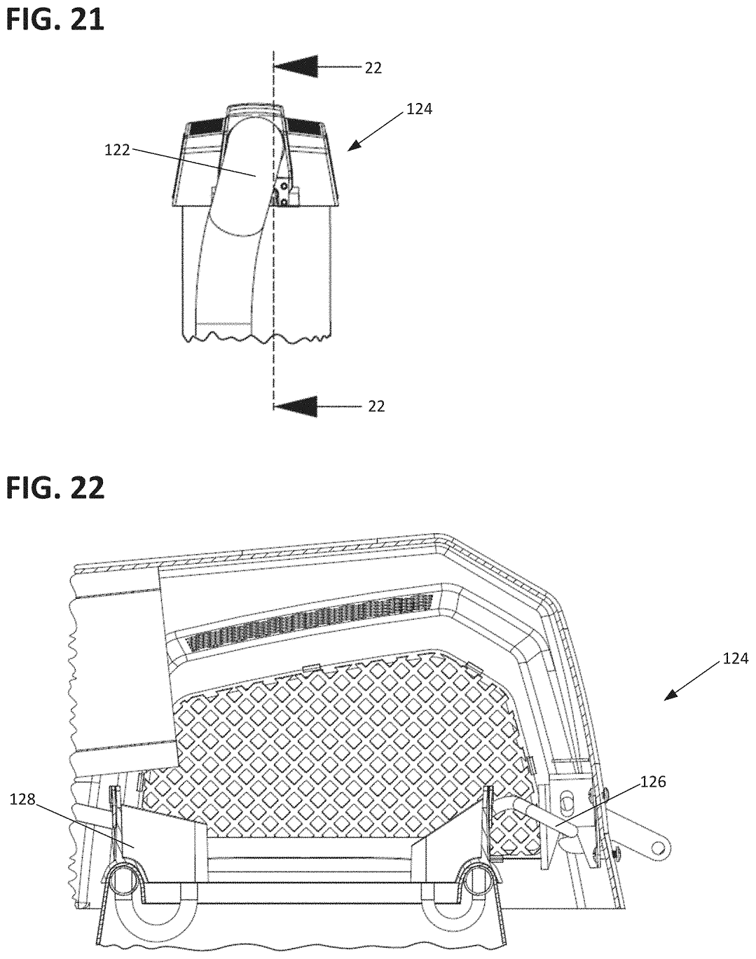

Referring to FIGS. 12 to 22, the installation of a collection bag 10 onto the debris collection machine 100 is illustrated. FIG. 12 shows an initial step in which the cover assembly 124 is placed in an open position relative to the support frame 126. When the cover assembly 124 is in an initially closed position, the handle 134b of the latch arrangement 134 can be moved in an upward direction to disengage the latch portion 134a from the looped latch portion 126r of the latch bar 126q. Once the cover assembly 124 is in the open position, a collection bag 10 can be placed beneath the support frame 126 and moved in the upward direction. Once the mouth of the collection bag 10 is vertically aligned with the main frame 126a of the support frame 126, as shown at FIG. 13, the collection bag 10 can be further moved vertically such that the main frame 126a is received into the interior of the collection bag 10, as shown at FIGS. 14 and 15. In this position, the bottom of the collection bag 10 is supported by the bag support platform 104d, which is shown in the exemplary drawings as being horizontal. Other orientations of the bag support platform 104d are possible. Once in this position, the top portion of the collection bag 10 can be folded over the main frame 126a top side 126m and perimeter interior surface 126p such that the top portion of the collection bag 10 generally extends back towards and/or into the interior of the collection bag 10, as shown at FIGS. 16, 17, and 22. Where a standard kraft paper bag is used, the paper has been found to be compliant enough to be folded in such a manner. Once the collection bag 10 has been installed as described, the cover assembly 124 can be returned to the closed position such that the collection bag 10 is clamped between the main frame 126a and the clamping surface 128c of the clamping section 128. To fully clamp and secure the collection bag 10, an operator applies a sufficient closing force to bring the latch arrangement 134 into engagement with the looped latch portion 126r of the latch bar 126q, whereby the latch arrangement 134 provides the necessary retention force. Notably, when the collection bag 10 is installed in such a manner, the collection bag 10 is oriented vertically such that the collection bag 10 can be filled to full capacity. Although a vertical orientation is advantageous in enabling the collection bag 10 to be fully filled, other orientations are possible. For example, the collection bag 10 could be disposed between vertical and 45 degrees from vertical in some applications. In some examples, the collection bag 10 is vertical at the clamping location and is non-vertical at a location remote from the clamping location.

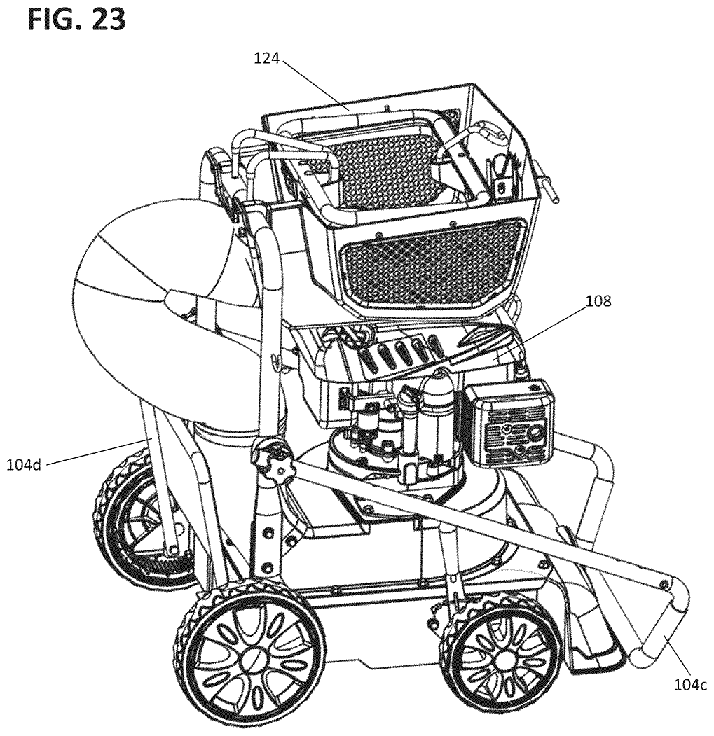

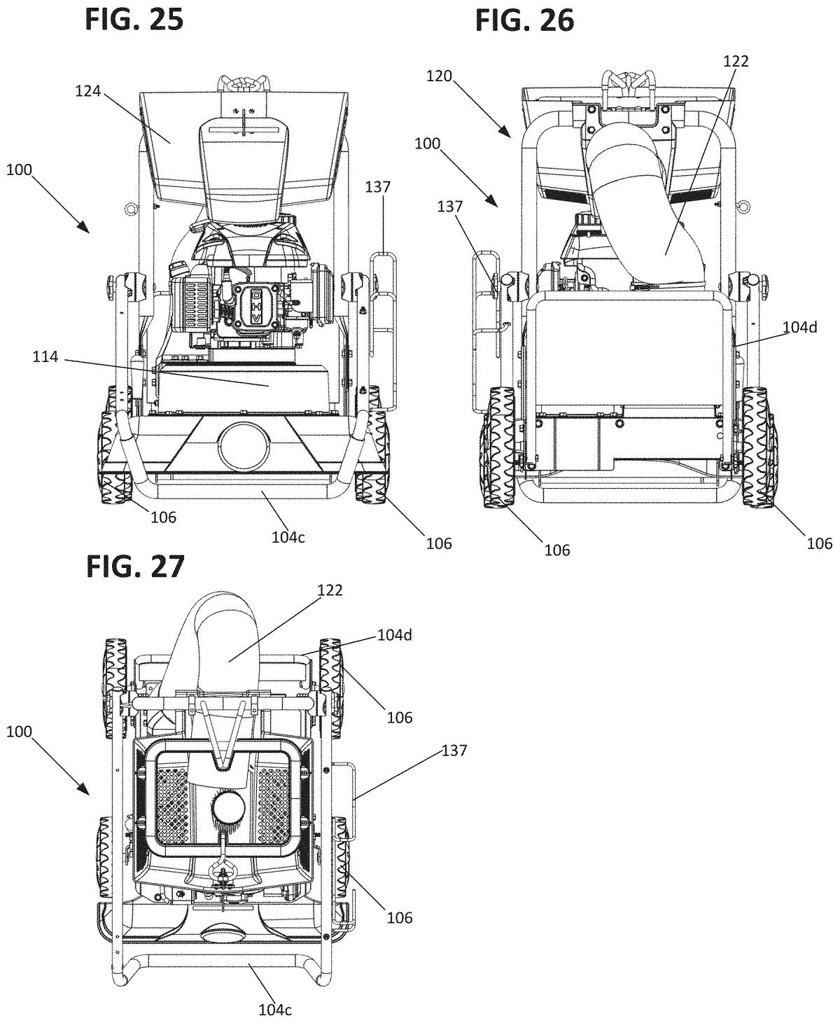

Referring to FIGS. 23 to 27, the debris collection machine 100 is shown as being placed in a storage position such that the overall length of the machine is shortened. In the storage position, the cover assembly 124 is rotated into the open position such that the top of the shroud body 130a rests on the motor 108. Additionally, the handle 104c is rotated fully forward such that the handle 104c is rotated over the motor 108. In the storage position, the bag support platform 104d is also rotated in an upward direction to shorten the length of the debris collection machine 100. The debris collection machine 100 can additionally include a bag rack 137 for the various bags discussed throughout. The bag rack 137 is shown in FIGS. 23-27 with the debris collection machine 100 in the storage position. However, the bag rack 137 can be included with the debris collection machine 100 in the normal upright position. The bag rack 137 is mounted to the handle 104c. The bag rack 137 is rotatable with the handle 104c so that paper bags can be held when the handle 104c is in the upright position.

The aforementioned components can be formed from a variety of materials using various different processes. For example, the support frame 126 can be formed from metal material while the cover assembly 124 shroud and clamping section 128 can be formed from an injection molded plastic material.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A debris collection machine comprising:
a) a vacuum assembly including:
i) a chassis including wheels mounted to the chassis;
ii) a motor mounted to the chassis;
iii) a housing having an inlet and an outlet; and
iv) a rotating component having a plurality of blades, the rotating component being positioned within the housing between the inlet and outlet, and being powered by the motor;
b) a collection assembly in communication with the outlet of the housing of the vacuum assembly, the collection assembly including:
i) a support frame being sized and shaped to be received by a collection bag; and
ii) a clamping section having an open position and a closed position, wherein, when in the closed position, the clamping section secures a portion of the collection bag between the clamping section and the support frame.

2. The debris collection machine of claim 1, wherein the support frame that receives the clamping section forms a bag receptacle ring.

3. The debris collection machine of claim 2, wherein the bag receptacle ring is rectangular.

4. The debris collection machine of claim 1, further comprising:
a. a cover including a permeable member and the clamping section, the cover being connected to the outlet of the vacuum assembly and connected to the clamping section, wherein the cover has an open position and a closed position, wherein, when in the closed position, the clamping section secures a portion of the collection bag between the clamping section and the support frame.

5. The debris collection machine of claim 4, wherein the cover further includes a shroud having at least one vent.

6. The debris collection machine of claim 4, wherein the cover is hingedly connected to the chassis.

7. The debris collection machine of claim 4, wherein the cover includes a latch, the latch being configured to selectably connect the cover to the support frame.

8. The debris collection machine of claim 1, wherein the wheels are propelled by the motor.

9. The debris collection machine of claim 1, wherein the chassis further includes a bag support platform.

10. The debris collection machine of claim 9, wherein the bag support platform is configured to support the collection bag in a vertical position.

11. The debris collection machine of claim 9, wherein the bag support platform is foldable between a support position and a storage position.

12. The debris collection machine of claim 1, further including a handle rotatably connected to the chassis, the handle being movable between an operating position and a storage position.

13. The debris collection machine of claim 4, wherein the motor supports the cover when the cover is in the open position.

14. The debris collection machine of claim 1, further including the collection bag.

15. The debris collection machine of claim 14, wherein the collection bag is non-permeable.

16. The debris collection machine of claim 14, wherein the collection bag is a paper bag having a generally rectangular cross-section.

17. A debris collection assembly for a debris collection machine, the debris collection assembly including:
a) a support frame including a main frame sized and shaped to be received into a collection bag; and
b) a cover including a shroud portion and a clamping section, the shroud portion including an opening for receiving an outlet of a debris conveyance tube, wherein the cover has an open position and a closed position, wherein, when in the closed position, the clamping section forms a clamping interface with the support frame such that the collection bag can be clamped between the clamping section and the support frame.

18. The debris collection assembly of claim 17, wherein the support frame has a generally rectangular shape.

19. The debris collection assembly of claim 17, wherein the support frame has a generally round cross-sectional shape and the clamping section has a clamping surface having a semi-circular cross-sectional shape.

20. The debris collection assembly of claim 17, wherein the support frame further includes a support member extending from the main frame, the support member configured for attaching the support frame to the debris collection machine.

21. The debris collection assembly of claim 20, further including a latch assembly mounted to the cover.

22. The debris collection assembly of claim 21, wherein the support frame further includes a latch bar extending from the main frame, the latch bar being configured for engagement with the latch assembly.

23. The debris collection assembly of claim 17, wherein the shroud portion defines one or more vent openings.

24. The debris collection assembly of claim 17, wherein the shroud portion is rotatable with respect to the main frame.
